(19) United States
(12) Patent Application Publication
(10) Pub. No.: US 2025/0033259 A1
(43) Pub. Date: Jan. 30, 2025

(54) METHOD FOR PRODUCING INTERCONNECTED COMPONENTS OF AN INTERIOR-TRIM PART, AND INTERCONNECTED COMPONENTS OF AN INTERIOR-TRIM PART

(71) Applicant: Volkswagen Aktiengesellschaft, Wolfsburg (DE)

(72) Inventors: Tobias KAHMANN, Helmstedt (DE); Detlef KRUEGER, Uetze (DE); Niklas SCHROEDER, Schwuelper (DE); Daniela WIECHOCZEK, Adenbuettel (DE)

(73) Assignee: Volkswagen Aktiengesellschaft, Wolfsburg (DE)

(21) Appl. No.: 18/914,121

(22) Filed: Oct. 12, 2024

Related U.S. Application Data
(63) Continuation of application No. PCT/EP2023/056280, filed on Mar. 13, 2023.

(30) Foreign Application Priority Data
Apr. 12, 2022 (DE) 10 2022 203 700.6

(51) Int. Cl. B29C 45/14; B29L 31/30; B60R 13/02

(52) U.S. Cl. CPC B29C 45/14778; B29C 45/14344; B29C 2045/14696; B29C 2045/14713; B29K 2995/0025; B29K 2995/0026; B29L 2031/302; B60R 2013/0287

(57) ABSTRACT

A method for producing interconnected components of an interior trim part. At least one decorative layer is translucent at least in areas. At least one body is light-permeable at least in sections. The body that is light-permeable at least in sections and an opaque structural part are produced as a multi-component structural part in a plastic injection molding process. The opaque structural part is produced in a first cavity of a mold in the plastic injection molding process and transferred into at least one part of a second cavity of a mold. A carrier film that carries the translucent decorative layer is positioned in another part of the second cavity. The body is produced, which is light-permeable at least in sections, in a space by a plastic injection molding process. A composite part that has the decorative layer, the body, and the opaque structural is removed from the mold.

This nonprovisional application is a continuation of International Application No. PCT/EP2023/056280, which was filed on Mar. 13, 2023, and which claims priority to German Patent Application No. 10 2022 203 700.6, which was filed in Germany on Apr. 12, 2022, and which are both herein incorporated by reference.

### BACKGROUND OF THE INVENTION

### Field of the Invention

The invention relates to a method for producing interconnected components of an interior trim part. The invention further relates to interconnected components of an interior trim part.

### Description of the Background Art

An interior trim panel and a method thereof for a motor vehicle is known from WO 2021/219552 A1, which is incorporated herein by reference.

In the method, first a decorative layer situated on a carrier film together with a light-permeable material is back-molded in a plastic injection mold. After the light-permeable material hardens, a light-permeable body results which is fixedly joined to the decorative layer. After the plastic injection mold is opened, a mold half on which the light-permeable body together with the decorative layer is situated is turned by 180 degrees. The turned plastic injection mold half is then supplied to a further half of an injection mold, thus forming a second cavity above the light-permeable body. The second cavity is subsequently filled with an opaque material in the plastic injection molding process. After hardening, interconnected components of an interior trim part result.

### SUMMARY OF THE INVENTION

It is therefore an object of the present invention to provide an alternative to the known methods. A further object of the invention is an alternative provision of interconnected components of an interior trim part.

The invention initially proceeds from a method for producing interconnected components of an interior trim part. The interconnected components comprise at least one decorative layer that is translucent at least in areas, at least one body that is light-permeable at least in sections, and at least one opaque structural part. The body that is light-permeable at least in sections and the opaque structural part are produced as a multi-component structural part in the plastic injection molding process. Within the meaning of the invention, a multi-component structural part is understood to mean a structural part that has at least two different material components, with each material component being produced in the plastic injection molding process.

The method according to the invention is characterized by the following steps. The opaque structural part is produced in a first cavity of a mold in the plastic injection molding process. Next, the opaque structural part is transferred into at least one part of a second cavity of the mold. A carrier film that carries the translucent decorative layer is positioned in another part of the second cavity in such a way that a space remains between the decorative layer and the opaque structural part in the closed state of the mold. The body, which is light-permeable at least in sections, is then produced in the stated space by a plastic injection molding process. Provided is a composite part comprising the decorative layer that is translucent at least in areas, the body that is light-permeable at least in sections, and the opaque structural part is removed from the mold.

Via these method steps, the basic prerequisite is met for suitability of the method for series production or even mass production. The method according to the invention may be carried out in a cost-effective manner, and is well suited for production of the interconnected components in series production in a large production volume. The composite part that is removed or removable from the mold is preferably made up of the decorative layer that is translucent at least in areas, the body that is light-permeable at least in sections, and the opaque structural part.

By use of such a method, it is possible that the part of the mold on which the carrier film together with the decorative layer is situated does not have to be moved during the method. Reliable positioning or repositioning of the decorative layer for each subsequent work operation is thus ensured.

Very rapid positioning of the decorative layer, which thus significantly speeds up the method, may be achieved by leading the carrier film, which carries the decorative layer, through the mold as an integral part of an unrollable continuous film.

The carrier film can be unrolled on one side of the mold and rolled up on an opposite side of the mold. The unrolling side may preferably be situated above the mold, and the rolling-up side may preferably be situated below the mold.

A contribution is made to further speeding up the method and carrying it out with greater process reliability when the transfer of the opaque structural part from the first cavity into the at least one part of the second cavity takes place in the same mold. In other words, a mold is advantageously used which has multiple, in particular two, stations. Transferring into a second, separate mold in a separate production machine is likewise possible.

Thus, in the first station, which in the mold forms the first cavity, initially the opaque structural part can be produced by injecting opaque plastic material. The second station of the mold then forms the second cavity, into the part of which the finished opaque structural part is transferred. Injection of light-permeable plastic material into the space that is formed by the decorative layer and the opaque structural part then takes place in the second cavity.

A contribution is made to process reliability and gentle material processing of the opaque structural part when the transfer of the opaque structural part from the first cavity into the at least one part of the second cavity takes place using a transfer gripper that acts on the opaque structural part mechanically and/or by negative pressure.

The method may be further speeded up when the opaque structural part, during the transfer from the first cavity into the at least one part of the second cavity, is initially withdrawn from the first cavity, then moved transversely, preferably only transversely, into alignment with the second cavity, and lastly inserted into the at least one part of the second cavity.

As stated above, a further aim of the present invention is to provide components of an interior trim part that are joined together (to form a composite part). Such components of an interior trim part comprise at least one decorative layer that is translucent at least in areas, at least one body that is light-permeable at least in sections, and at least one opaque structural part. The body that is light-permeable at least in sections and the at least one opaque structural part are produced as a multi-component structural part in the plastic injection molding process. According to the invention, the components of the interior trim part are produced using the described method according to the invention. Thus, as described, the components may be produced in a cost-effective manner in a method that is suitable for series production or even mass production.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a through 1i show an illustration of method steps of an example of the method according to the invention,

FIG. 2 shows an illustration of a mold together with the two cavities utilized for the method,

FIG. 3 shows a sectional illustration of an interior trim part that includes components produced using the method, according to cut line III from FIG. 4,

FIG. 4 shows a view of the interior trim part according to view IV from FIG. 3, and

FIG. 5 shows the interior of a motor vehicle with interior molding parts which include components that are produced by the method according to the invention.

### DETAILED DESCRIPTION

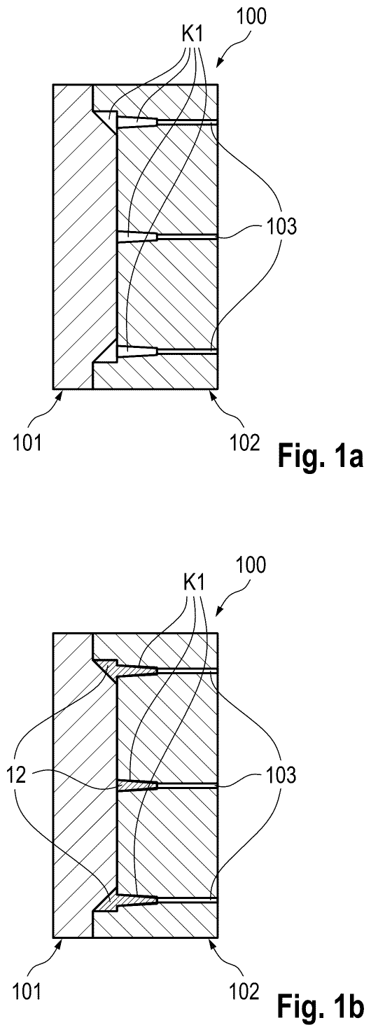

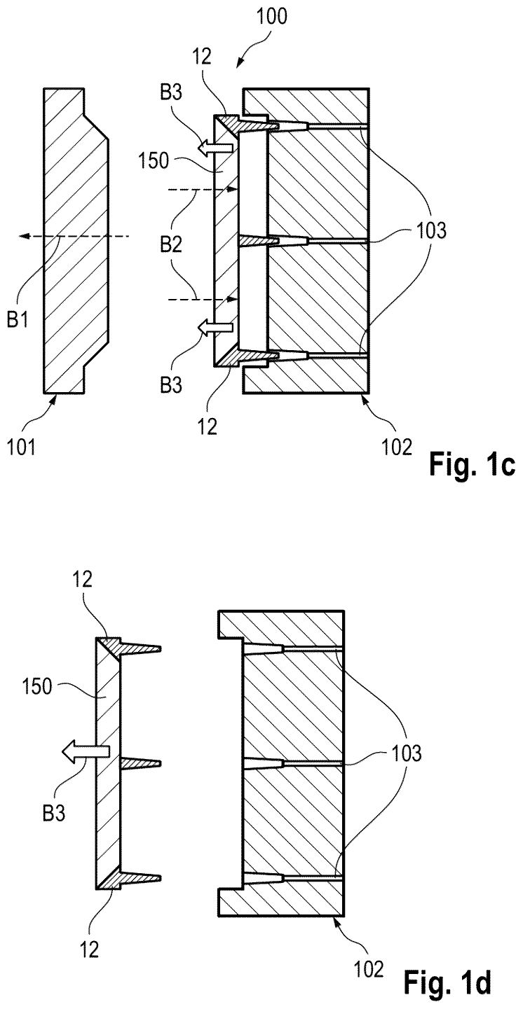

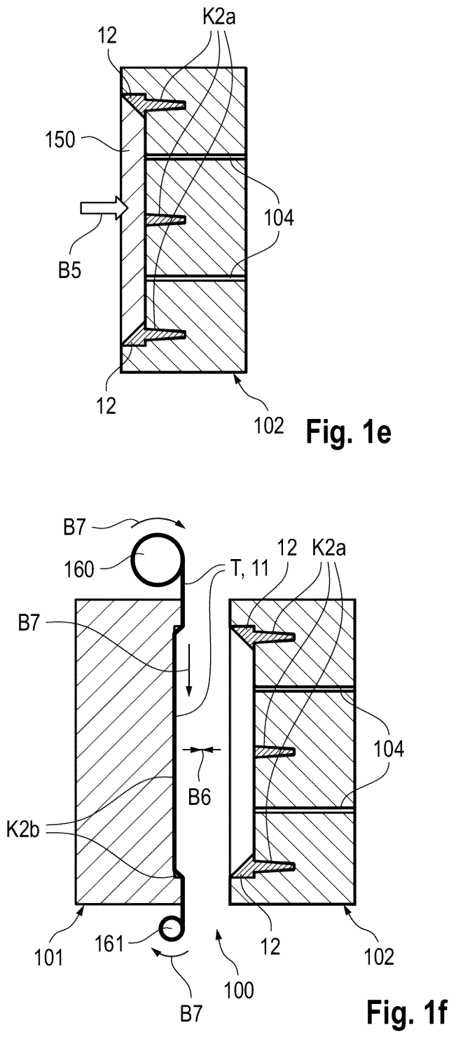

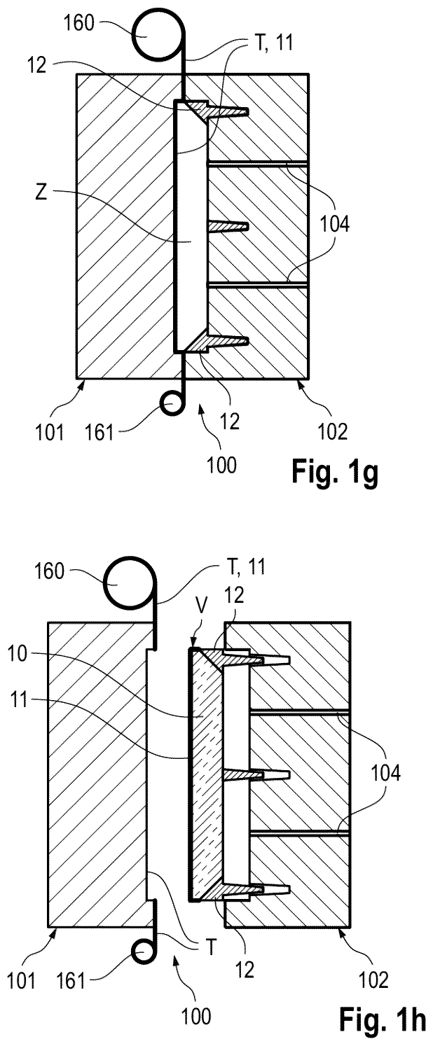

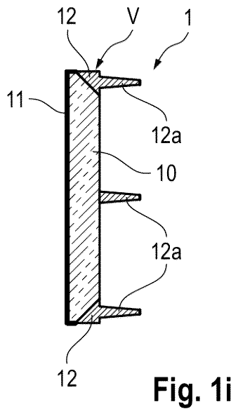

Reference is first made to FIGS. 1a through 1i.

The figures illustrate a mold 100 for carrying out a plastic injection molding process. The mold 100 has a mold part 101 and a mold part 102. In the figures, only feed channels 103 and 104 for feeding melted plastic granules to a cavity to be filled in each case are indicated.

FIG. 1a illustrates the mold 100 in the closed state. The mold parts 101 and 102 are thus joined together. This results in a first cavity K1 in the mold 100.

FIG. 1b illustrates the state in which the first cavity K1 is filled with plastic material via the feed channels 103, and the plastic material has already cooled to form an opaque structural part 12.

With reference to FIG. 1c, it is apparent how the mold 100 has been subsequently opened by a movement B1 of the mold part 101. It is also illustrated how the opaque structural part 12 is withdrawn from the mold part 102 in a movement B3 by use of a transfer gripper 150.

The transfer gripper 150, with the mold 100 open, has previously been placed on the opaque structural part 12 in a movement B2. The transfer gripper 150 acts on the opaque structural part 12 via negative pressure and/or mechanically in such a way that the opaque structural part 12 may be moved as desired by the transfer gripper 150 in a manner that is very gentle on the structural part.

The movement B3 of the transfer gripper 150 takes place until the opaque structural part 12 is completely led out of the mold part 102. This is illustrated in FIG. 1d, with the mold part 101 no longer being illustrated for the sake of simplicity.

The opaque structural part 12 is subsequently moved transversely (thus, in the present case, perpendicularly to the plane of the drawing) across the mold part 102 by use of the transfer gripper 150 until it is congruently aligned with parts K2a and K2b of a second cavity. When this has been achieved, the opaque structural part 12 is inserted, via a movement B5, into the part K2a of the second cavity, which is formed by the mold part 102. The other part K2b of the second cavity is in turn formed in the mold part 101 (see FIGS. 1e and 1f).

It is also apparent that a decorative layer 11 situated on a carrier film T is positioned in the part K2b of the second cavity. For the sake of simplicity, the carrier film T and the decorative layer 11 (although they form two layers) are illustrated only as a single line. The decorative layer 11 is translucent at least in areas.

Furthermore, it is apparent that the carrier film T carrying the decorative layer 11 is led through the mold 100 as an integral part of an unrollable continuous film. In particular, the carrier film T is unrolled from a roller 160 on one side of the mold 100, preferably above the mold 100, and is rolled onto a roller 161 on an opposite side of the mold 100, preferably below the mold 100.

It is apparent in FIG. 1f that prior to each subsequent work operation, the carrier film T together with the decorative layer 11 is positioned in a preferably vertical movement B7, and the mold 100 is subsequently closed once again in a movement B6.

FIG. 1g shows the closed state of the mold 100. A space Z is formed between the decorative layer 11, situated on the carrier film T, and the opaque structural part 12.

Melted plastic granules are subsequently supplied to the space Z via feed channels 104 in an injection molding operation. The supplied plastic granules are light-permeable, and after hardening form a light-permeable body 10 (see FIG. 1h).

FIG. 1h illustrates how, after the light-permeable plastic material has hardened to form the light-permeable body 10, the mold 100 is pulled apart, and a composite part V comprising the decorative layer 11, the light-permeable body 10, and the opaque structural part 12 is removed from the mold part 102.

It should be noted that due to filling the space Z with melted plastic material (see FIG. 1g), the decorative layer 11 has become fixedly joined to the light-permeable body 10 in such a way that when the mold 100 is opened, the decorative layer 11 joined to the light-permeable body 10 is completely detached from the carrier film T. For the sake of clarity, a handling tool for moving the composite part V is not illustrated in FIG. 1h.

Lastly, FIG. 1i shows the state in which the composite part V has been completely removed from the mold 100. It is also apparent that the opaque structural part 12 has weld ribs 12a for further fastening of the composite part V to further structural parts, as explained in greater detail below.

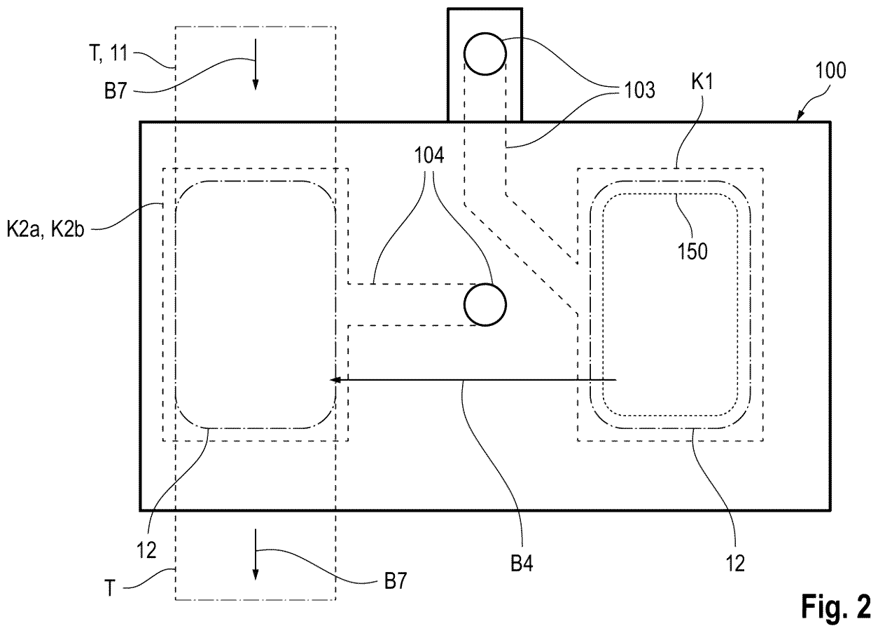

For better understanding of the method, another perspective of the mold 100 is shown in an extremely schematic illustration in FIG. 2. With reference to this figure, the intent is solely to clarify that the first cavity K1 and the second cavity formed from the parts K2a and K2b are situated in the same mold 100. The feed channels 103 and 104 are only schematically indicated. In addition, the opaque structural part 12 situated in the first cavity K1 is indicated. After the mold 100 is opened and the opaque structural part is withdrawn from the mold part 102, by means of the likewise indicated transfer gripper 150 the opaque structural part is moved in a transverse movement B4 toward the parts K2a and K2b of the second cavity, and is aligned with same (also see FIGS. 1d through 1g). It is also apparent in this figure that the carrier film T is guided through the mold, from one side of the mold 100 to the opposite side of the mold 100.

In the example, in the movement B7 the carrier film T is led from top to bottom through the mold 100.

Due to the procedure performed, namely, initially injecting the opaque structural part 12 into the first cavity K1, and back-molding the light-permeable decorative layer 11 with light-permeable plastic material only after the opaque structural part 12 is transferred into the second cavity of the mold 100, the carrier film T together with the rollers 160, 161 (see FIGS. 1f through 1h) does not have to be swiveled or rotated.

Instead, the carrier film T may remain aligned above the parts K2a, K2b of the second cavity, and for positioning prior to a subsequent work operation only needs to be moved far enough through the mold 100 until the carrier film T with the decorative layer 11 situated thereon is once again positioned precisely at the level of the parts K2a, K2b of the second cavity.

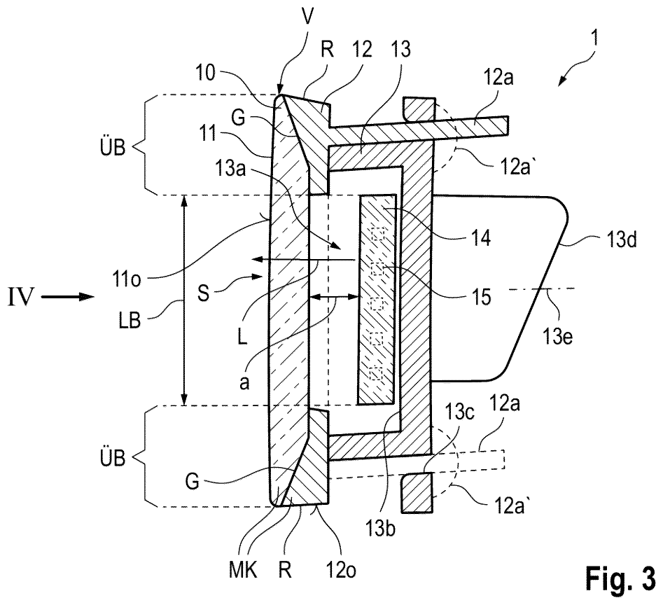

The basic design of an interior trim part 1 is described in greater detail with reference to FIG. 3; the interior trim part has interconnected components that have been produced using the method according to the invention (also see FIG. 1i).

Thus, it is apparent from the figure that the interior trim part 1 includes the light-permeable body 10. The light-permeable body 10 is preferably transparent, i.e., has a clear design. It is also possible for the light-permeable body 10 to be colored and/or to have merely a translucent design.

The light-permeable body 10 also has a flat design. Its areal extent is thus several times greater than its thickness.

One side of the light-permeable body 10 is covered by the decorative layer 11, which is translucent at least in areas. The decorative layer 11 thus represents a visible side S for a vehicle occupant situated in the interior of a motor vehicle K (also see FIG. 5).

The decorative layer 11 is preferably a decorative layer that is produced in the so-called in-mold decoration (IMD) process. It may be made up of one or also multiple colored layers or paint layers. The decorative layer 11 is light-permeable in areas, and may thus contain a translucent pattern, translucent characters and/or symbols, or the like.

The light-permeable body 10, as explained above for the method, is molded onto the decorative layer 11, i.e., fixedly joined to the decorative layer 11.

Furthermore, the light-permeable body 10 on its rear side is covered by the opaque structural part 12 in the edge region. The opaque structural part 12, as explained above, is likewise molded onto the light-permeable body 10, i.e., also fixedly joined to the light-permeable body 10.

The light-permeable body 10 and the opaque structural part 12 thus form a multi-component structural part MK made up of multiple undetachably interconnected components. In particular, the multi-component structural part MK is a two-component structural part made up of a light-permeable material component and an opaque material component. A circumferential edge of the multi-component structural part MK is denoted by reference symbol R.

The opaque structural part 12 has a contour with a frame-like design. This results in an illumination area LB that is translucent to light beams L. The light beams L may be generated by one or more illuminants 15 (preferably light-emitting diodes) situated in the interior trim part 1.

The multi-component structural part MK or its opaque body 12 is fixedly joined, preferably welded, to a likewise opaque mounting 13. The mounting 13 may preferably be provided with a reflective inner coating, and may thus act as a reflector.

For this purpose, the opaque structural part 12 has weld ribs 12a that are inserted into through openings 13c in the mounting 13 and are converted to weld projections 12a′ via a welding operation, resulting in a form-fit connection between these structural parts.

An essentially closed receiving space 13a in which a light guide 14 is accommodated is thus formed between the multi-component structural part MK and the mounting 13.

The mounting 13 is thus used for mounting the light guide 14. The light guide 14 likewise has a flat design, and rests on a base 13b of the mounting 13.

The receiving space 13a is preferably dimensioned in such a way that a clear distance a remains between the light guide 14 and the light-permeable body 10.

The light guide 14 is likewise preferably designed as a transparent body. At its rear side facing away from the light-permeable body 10, the light guide may have light decoupling structures, via which the light that is coupled laterally into the light guide 14 from the illuminants 15 is decoupled in the direction of the light-permeable body 10. The mounting 13 designed as a reflector may also contribute in this regard.

It follows from the figure that the light-permeable body 10 on the visible side S is completely covered by the decorative layer 11. In particular, the decorative layer 11 may be guided up to the opaque structural part 12. The decorative layer 11 thus rests against the opaque structural part 12 at an edge side or end-face side.

The light-permeable body 10, the opaque structural part 12, and the decorative layer 11 are preferably designed in such a way that a surface 110 of the decorative layer 11 and a surface 120 of the opaque structural part 12 abut in flush alignment in the region of the stated circumferential edge R.

It is also possible that the light-permeable body 10 can have a slightly smaller design, so that the stated surfaces 110 and 120 do not abut in flush alignment, but instead result in so-called shingling. However, the shingling takes place only in such a way that the opaque structural part 12 projects beyond the light-permeable body 10 at the edge.

In any case, it is pointed out that the decorative layer 11 is guided up to the opaque structural part 12. Thus, when the decorative layer 11 is guided up to the opaque structural part 12, there is no longer a gap between the decorative layer 11 and the opaque structural part 12 through which undesirable scattered light could escape.

In the region of the edge R of the interior trim part 1, such a design results in a lighting encapsulation of the light-permeable body 10 by the decorative layer 11 on one side, and by the opaque structural part 12 on the other side.

The basic prerequisite is thus met for very efficiently avoiding undesirable scattered light.

As is further apparent with reference to FIG. 3, the multi-component structural part MK creates a circumferential overlap region ÜB in which the material components of the light-permeable body 10 and of the opaque structural part 12, which form a material interface G, rest against one another.

It is apparent from the illustration that the material interface G, starting from the circumferential edge R of the multi-component structural part MK, extends inwardly, at least in sections, in such a way that the material of the light-permeable body 10 continuously increases, while the material of the opaque structural part 12 continuously decreases.

Such a material profile very favorably influences the flow properties of the materials during the production process, so that material defects, for example discolorations in the light-permeable body 10, may be avoided to the greatest extent possible.

Also worth noting are even further fastening projections 13d on the rear side, at the ends of which the interior trim part 1 may be fastened in the interior of a motor vehicle by use of fastener 13e (screw connections, for example).

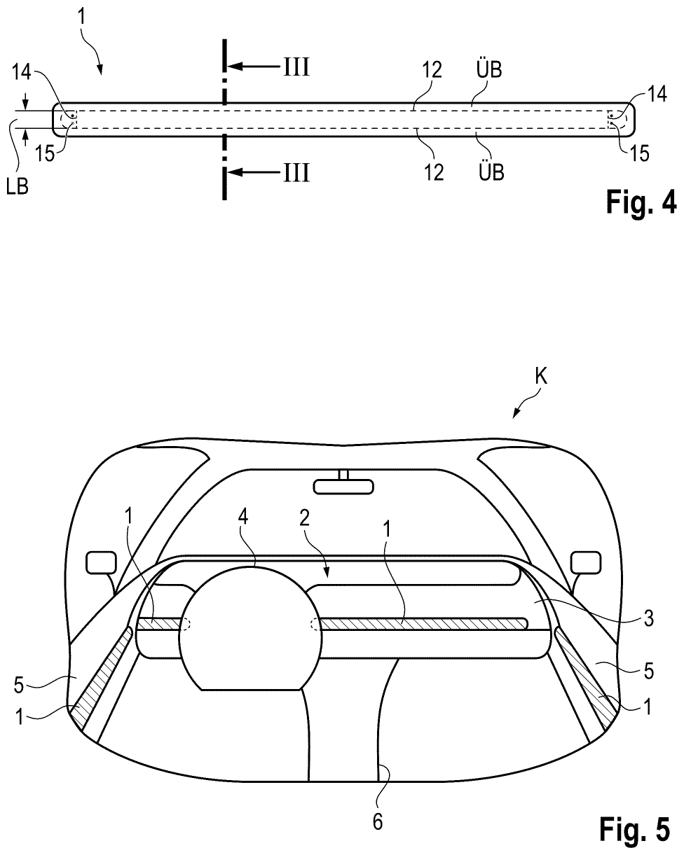

FIG. 4 illustrates the interior trim part 1 in a top view, on its contour viewed from the visible side S.

The frame-like, circumferential opaque structural part 12, via which the window-like illumination area LB and the circumferential overlap region ÜB on the edge are formed, is indicated by dashed lines.

Also indicated is the elongated, flat light guide 14, at the opposite end-face sides of which the illuminants 15 are situated, whose light may be coupled into the light guide 14.

Lastly, reference is made to FIG. 5. An interior of a motor vehicle K in the area of a cockpit 2 is apparent in this figure. An instrument panel 3, a steering wheel 4, side door moldings 5, and a center console 6 are discernible in the interior of the motor vehicle K. Also illustrated are multiple elongated, strip-like interior trim parts 1 that extend horizontally across the instrument panel 3 and along the door moldings 5. Each of the interior trim parts 1, as explained, includes interconnected components that have been produced with the aid of the method according to the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing an interconnected component of an interior trim part comprising at least one decorative layer that is translucent at least in areas, at least one body that is light-permeable at least in sections, and at least one opaque structural part, the body that is light-permeable at least in sections and the opaque structural part are produced as a multi-component structural part in a plastic injection molding process, the method comprising:
producing the opaque structural part in a first cavity of a mold in the plastic injection molding process;
transferring the opaque structural part into at least one part of a second cavity of a mold;
positioning a carrier film that carries the translucent decorative layer in another part of the second cavity such that a space remains between the decorative layer and the opaque structural part;
producing the body, which is light-permeable at least in sections, in the space by a plastic injection molding process; and
removing from the mold a composite part comprising the decorative layer that is translucent at least in areas, the body that is light-permeable at least in sections, and the opaque structural.

2. The method according to claim 1, wherein the carrier film carrying the translucent decorative layer is led through the mold as an integral part of an unrollable continuous film.

3. The method according to claim 2, wherein the carrier film is unrolled on one side of the mold and rolled up on an opposite side of the mold.

4. The method according to claim 1, wherein the transfer of the opaque structural part from the first cavity into the at least one part of the second cavity takes place in the same mold.

5. The method according to claim 1, wherein the transfer of the opaque structural part from the first cavity into the at least one part of the second cavity takes place using a transfer gripper that acts on the opaque structural part mechanically and/or by negative pressure.

6. The method according to claim 1, wherein during the transfer from the first cavity into the at least one part of the second cavity, wherein the opaque structural part is initially withdrawn from the first cavity, then moved transversely into alignment with the second cavity, and inserted into the at least one part of the second cavity.

7. The method according to claim 1, wherein the interior trim part is a motor vehicle interior trim part.

8. An interconnected component of an interior trim part comprising:
at least one decorative layer that is translucent at least in areas;
at least one body that is light-permeable at least in sections; and
at least one opaque structural part,
wherein the body that is light-permeable at least in sections and the at least one opaque structural part are produced as a multi-component structural part in a plastic injection molding process, and
wherein the interconnected component of the interior trim part is produced by the method according to claim 1.
